(19) United States
(12) Patent Application Publication
(10) Pub. No.: US 2021/0312346 A1
(43) Pub. Date: Oct. 7, 2021

(54) Financial Monitoring and Forecasting Systems and Methods

(71) Applicant: Formula Technologies, Inc., Dallas, TX (US)

(72) Inventors: Art Porth, Geneva, IL (US); David McMackin, Monterey, CA (US); Michael McMackin, Pebble Beach, CA (US)

(73) Assignee: Formula Technologies, Inc.

(21) Appl. No.: 17/348,268

(22) Filed: Jun. 15, 2021

Related U.S. Application Data
(63) Continuation of application No. 17/159,873, filed on Jan. 27, 2021.
Application No. 17/159,873 is a continuation of application No. 15/373,413, filed on Dec. 8, 2016, now abandoned.
(60) Provisional application No. 62/264,431, filed on Dec. 8, 2015.

(51) Int. Cl. G06Q 10/04; G06Q 40/04; G06Q 30/02; H04L 12/58; H04W 4/14; G06F 3/0481; G06Q 10/08; G06Q 10/10

(52) U.S. Cl. CPC G06Q 10/04; G06Q 40/04; G06Q 30/0283; H04L 51/08; H04W 4/14; G06F 3/0482; G06Q 10/087; G06Q 10/1053; G06Q 30/0201; G06Q 30/0204; G06F 3/0481

(57) ABSTRACT

A system provides real-time financial valuation information for entities that process financial transactions across multiple currencies. The system includes one or more business location processing devices, one or more external data processing devices, and a central processing device that receives transaction data from the one or more business location processing devices. The central processing device further receives the transaction value modifying data from the one or more external data processing devices, and, in response to the receipt of the transaction data and the transaction value modifying data, generates modified transaction data comprising the transaction data modified by the transaction value modifying data, the modified transaction data being accessible through a graphical user interface provided through an end user processing device, the graphical user interface providing at least one user option for viewing real-time, aggregated, modified transaction data derived from transaction data comprising two or more currencies.

### CROSS-REFERENCE TO RELATED APPLICATIONS

This application comprises a continuation of U.S. application Ser. No. 17/159,873 filed Jan. 27, 2021, which is a continuation of U.S. application Ser. No. 15/373,413 filed Dec. 8, 2016, which incorporates by reference and claims the benefit of priority to U.S. Provisional Patent Application No. 62/264,431 filed Dec. 8, 2015, the entireties of which are hereby incorporated.

### BACKGROUND OF THE INVENTION

The present subject matter relates generally to a systems and methods of collecting, analyzing, and displaying financial and other forms of business data. More specifically, the present invention relates to a real time global business data reporting system which is capable of accounting for all revenue generated to international companies and analyzing this data to, in turn, generate business intelligence and display advice to end users.

Doing business in emerging markets has transitioned from being an innovative and unconventional source of income for corporations to a modern day necessity. This fact is witnessed by the amount of investment in emerging markets, with hedge fund capital in such markets reaching record levels in a single quarter of 2011 at 121 billion USD. Additionally, the term “emerging markets”, used to describe countries with not yet fully developed economies (e.g., China, India, Brazil, etc.), has itself fallen into disfavor with no new terminology arising to take its place. This is because corporations and the rest of the business world no longer view other countries as developed, emerging, or less developed and are instead increasingly globally minded; viewing the world as one single market.

This worldwide, single market view has led to many useful innovations, particularly with supply chain and logistics management. Most, if not all major corporations currently have real time access to all their inventory levels, shipments, and even the status of their industrial equipment. This sort of organization wide data visibility and granularity is enabled by large scale computerized enterprise resource planning (ERP) and customer relationship management (CRM) systems. These centralized systems are so valuable that, as of 2004, around 80 percent of Fortune 500 companies utilized an ERP system. The past decade has seen this level of adoption continue to rise, but not every aspect of a company's resources are covered by current ERP, CRM, and other similar business management technologies.

Likely one of the biggest limitations in current business management technologies and, in turn a limitation on companies fully embracing a worldwide, single market view, is the lack of revenue generation and management systems featuring real time data reporting and multinational/international support. As mentioned above, the growth of markets outside the US has risen dramatically in recent years and corporations have had to scramble to adjust how revenue is being accepted in foreign countries and how to account for exchange rates, taxes, regulations, etc. All of this information is difficult to account for as, outside of the US, many companies are forced to operate within their own specific “silo” for payment acceptance. This means each company, individually, has to navigate a disparate series of foreign national and international banks, payment processing systems, providers, and connections. There is no current entity which offers a standardized payment platform for international business.

This lack of standardized payment acceptance system means not only can some businesses not accept all payment types (e.g., some business may only take Visa credit cards), but that data for revenue actually accepted can also become degraded due to latency in reporting. This latency in financial messaging and reporting is no better illustrated that with the Society for Worldwide Interbank Financial Telecommunication (SWIFT). SWIFT is currently the near exclusive financial messaging provider for the top 2000 global retailers and monitors each and every corporate bank account for these global companies. SWIFT sends millions of messages on a daily basis (within a 24-48 hours from the time a transaction actually occurs, at best) to inform participating corporations of revenue events received.

While SWIFT provides best in industry financial messaging, the data they provide is still, at best, a day old, in a cumulative amount and used only for account balancing, funds movement, and not real time business decisions. Merchant statements are used for these same purposes but are yet even more dated than SWIFT messages, with the data reported on these statements taking a month or more to be received by companies at the corporate level. Given that doing business internationally, while more common now than ever, means dealing with countless governments' rules and regulations which can be more volatile than what US corporations, and their financial systems and procedures are accustomed to (e.g., recent overnight currency devaluations seen in China and Argentina, etc.), even a single day delay in financial reporting can be disastrous to a company.

Accordingly, there is a need for a real time global business data reporting system which is capable of accounting for worldwide revenue to international companies and analyzing this data to in turn generate predictive business intelligence and display advice to end users.

### BRIEF SUMMARY OF THE INVENTION

To meet the needs described above and others, the present application discloses both real time global business data reporting systems and methods which are capable of accounting for all revenue generated within international companies and analyzing this data to in turn generate business intelligence and display advice to end users.

In one embodiment, the invention may consist of a computerized network system which features a centralized server or servers that collect data from a company's business locations (both physical and online) located around the world. The collected data is collated and synthesized with other sources of data useful to a company (e.g., real time weather data, exchange rates, financial news, geopolitical news, societal events, epidemiological data, etc.) and then analyzed by a series of proprietary algorithms. These algorithms, while described in the application as programs, are not physically separate and instead work seamlessly together in a virtual environment to allow the system to display for an end user (typically someone at the corporate management level) a graphical user interface (GUI). This GUI displays both real time and predictive data related to financial and human resources of a company. The embodiment disclosed in the application is designed with financial business concerns in mind, but can be optimized to instead account for other business needs such as inventory management, industrial equipment allocation, etc.

The system GUI of this embodiment features a dashboard which provides end users with a global summary of financial assets on hand at a given moment for their entire company. The data displayed is collected in real time by the system's centralized server from every branch, franchisee, affiliate, or other business establishment within the purview of a given company's financial reporting systems. At each local business site, a company, via the present invention, may collect data related to both card swipe transactions (e.g., credit, debit, or bank card payments), cash on hand or other value exchanged. This data may be collected manually or automatically by the present invention; ideally with all business locations using the same centralized payment acceptance platform. However, the system is also capable of being integrated with and communicating with any physical or virtual revenue recording devices (e.g., cash registers, card readers, online virtual device etc.) or local accounting software systems. Other relevant business data, such as staffing information and inventory levels may also be reported by the local business sites to the centralized server.

Once the relevant data is collected locally, it is then transmitted to the centralized server or servers of the present system via internet connection or any other functional data transmission means. The data may be stored locally, with a clone of the data sent to the centralized servers or a direct connection may be utilized where local and or virtual business locations utilizes a terminal (or online revenue acceptance system), which stores information directly on the centralized servers. However the data is received by the system servers, once the data enters the servers; it is organized and analyzed by various algorithms running on the server for display on the system's GUI. These algorithms allow for the data collected to be viewed in real time via graphical maps, charts, tables, and exported in any functional format to other software systems (e.g., ERP systems, CRM systems, payroll systems, etc.). The algorithms also provide users with “smart” feedback in the form of alerts and advice about how to best optimize their companies finances.

This “smart” feedback is provided by system algorithms which analyze the monetary and other data provided from the various business locations of a company in combination with other real world data sources (e.g., financial and world news, weather data, etc.) to generate predictive alerts and advisory actions for a company to take. An example of the predictive feedback provided by the system might deal with currency devaluation. The governments of some counties (e.g., China, Argentina, etc.) set the value of their currency instead of letting it float relative to other currencies. This creates a potentially disastrous situation for a multinational corporation with locations within such countries as the governments of these countries may literally, in an instant, devalue the currency of a local institution has on hand and in its local bank accounts by a substantial amount.

This very situation occurred around the turn of the millennium in Argentina when the government halved the value of Argentine currency overnight. Multi-national corporations with assets in the country were stuck, either being forced to take the loss of half their assets when moving them out of the county or infuse more money into their Argentine assets to keep them viable. With the present invention in place, indicators for currency devaluations, political unrest, and any other known sources of financial trouble can be monitored by the system in real time. If there was an indication of a possible currency devaluation, the present system can be set up to provide alerts of such impending action and advise end users what actions to take to avoid being “stuck” like corporations of the past. The system may even be set up to automatically move money and other assets out of a country as much as possible to best preserve a company's assets in the view of an impending disaster in a country (financial in nature or otherwise).

Another example of predictive advice the present system can provide deals with staffing management. The present system may take into account real time weather data for all locations a company operates throughout the world. The system may then use this data to determine the number of staff needed at a given location on a given day and send alerts to local and corporate management to prevent overstaffing on slow business days. The staffing needs may be assessed based off historical staffing data stored by the centralized server and how it related to weather conditions of the past dates or utilize other data to determine the staffing needs for a given business location on a given day.

The business intelligence methods this system provides are not just predictive in nature and also help end users monitor currency fluctuations in real time. As mentioned above, some countries let the value of their currency float relative to other countries. For a multi-national corporation, this means the value of financial assets and inventory held by various business locations in different countries may vary from day-to-day making pricing very difficult and time consuming. The present system may analyze pricing data in real time to ensure all prices are appropriate relative to ever changing currency values. If the price of an item it too low in a given country, the present system may alert corporate management of the issue so they can adjust the price. The system may also adjust prices automatically if structured to do so and can even be integrated with modern digital menu board and price displays to automatically update the prices displayed to consumers as soon as an issue with pricing is identified.

Describing system functionality another way, one portion of this system may provide real-time financial valuation information for entities that process financial transactions across multiple currencies. To provide this functionality, the system may feature a central processing device (e.g., host server, cloud server, etc.) that receives transaction data (e.g., data on sales, returns, etc.) from one or more business location processing devices (e.g., physical revenue recording device (cash register), etc.), the transaction data including quantitative measurements of the financial value of transactions processed by each business location processing device, including at least the value received and any tax liabilities associated with the value received; the central processing device further receiving transaction value modifying data from one or more external data processing devices (e.g., financial news data sources, stock market data, etc.), the transaction value modifying data including at least one of currency exchange rate data and regional tax liability data; wherein, in response to the receipt of the transaction data and the transaction value modifying data, the central processing device generates modified transaction data comprising the transaction data modified by the transaction value modifying data, the modified transaction data accessible through a graphical user interface provided through an end user processing device (e.g., mobile computing devices, etc.), the graphical user interface providing at least one user option for viewing real-time, aggregated, modified transaction data derived from transaction data comprising two or more currencies (e.g., reports, graphs, etc.).

In one example of the embodiment of the system, the transaction value modifying data includes one or more currency value modifiers derived from geopolitical events. In another, the transaction value modifying data includes one or more currency value modifiers derived from stock market data. The transaction value modifying data may also include one or more currency value modifiers derived from aggregated, anonymized data derived from operational data from a plurality of businesses.

At least one business location processing device may be a physical revenue recording device or an online payment system. The modified transaction data may include at least one assessment of the current gross worth of the monetary assets of a company, at least one assessment of the current gross worth of the inventory of a company, at least one assessment of the current net worth of the monetary assets of a company, at least one assessment of the fees owed related to the monetary assets of a company, and/or at least one assessment of the refunds owed related to the monetary assets of a company.

The graphical user interface may be displayed in a web browser and the end user processing device may be a mobile computing device.

In one example, the system generates an alert message based off the modified transaction data placing the system into a state of alarm. The alert message generated may be an SMS message, an email, an automated telephonic message, and/or may be machine readable and communicated via an electronic data interface.

In another example, a system that provides real-time financial valuation information for entities that process financial transactions across multiple currencies includes: an end user processing device providing a graphical user interface, the graphical user interface providing at least one user option for viewing real-time, aggregated, modified transaction data derived from transaction data comprising two or more currencies; wherein the transaction data is received by a central processing device that receives the transaction data from one or more business location processing devices, the transaction data including quantitative measurements of the financial value of transactions processed by each business location processing device, including at least the value received and any tax liabilities associated with the value received; wherein the central processing device further receiving transaction value modifying data from one or more external data processing devices, the transaction value modifying data including at least one of currency exchange rate data and regional tax liability data; wherein, in response to the receipt of the transaction data and the transaction value modifying data, the central processing device generates the modified transaction data comprising the transaction data modified by the transaction value modifying data. In this example of the system, the transaction value modifying data may include data derived from geopolitical events, data derived from stock market data, or data derived from aggregated, anonymized operational data from a plurality of businesses; the transaction value modifying data may features at least one assessment of the current gross worth of the monetary assets of a company, at least one assessment of the current net worth of the monetary assets of a company, at least one assessment of the fees owed related to the monetary assets of a company, at least one assessment of the taxes owed related to the monetary assets of a company, or at least one assessment of the refunds owed related to the monetary assets of a company; and the system may generate an alert message based off the transaction value modifying data placing the system into a state of alarm, wherein the alert message is an SMS message, is an email, is an automated telephonic message, or is machine readable and communicated via an electronic data interface.

In another example, the system may also provide business resource needs forecasts. To provide such functionality, a central processing device (e.g., host server, cloud server, etc.) may receive real-time resource data from one or more business location processing devices (e.g., mobile computing devices, inventory management systems, etc.), the company resource data including quantitative data selected from the group consisting of financial data, staffing data, and inventory data; the central processing device further receiving comparison resource data from one or more external data processing devices, the comparison resource data (e.g., historical business performance data, etc.) including quantitative data selected from the group consisting of financial data, staffing data, and inventory data, the comparison resource data further being associated with external factor data, the external factor data being selected from the group consisting of economic data, weather data, and political data; the central processing device further receiving real-time external factor data, the external factor data including data selected from the group consisting of consisting of economic data, weather data, and political data; wherein, in response to the receipt of the real-time resource data, real-time external factor data, and the comparison resource data associated with external factor data, the central processing device generates an automated call to action (e.g., alert SMS, email, XML message, etc.) including a suggested modification of the real-time resource data and communicates the call to action to the one or more business location processing devices.

In such an example, the suggested modification of the real-time resource data may relate to the staffing needs of a company. In another example, the suggested modification of the real-time resource data may relate to inventory needs for a company. The call to action may be an alert message distributed via email, an alert message distributed via SMS, an alert message distributed via telephonic message, or an alert message in a machine readable format and communicated via an electronic data interface. The business location processing device may be a physical revenue recording device, a mobile computing device, a desktop computer, or business process management software.

Still another system embodiment can be described as pricing management that is enabled by a central processing device (e.g., host server, cloud server, etc.) that receives a goal price for a product or service from a first user device (e.g., mobile device, desktop computer, ERP software, etc.), the goal price being a first numerical value of a first currency; the central processing device further receiving a real-time price for the product or service from one or more business location processing devices (physical revenue recording device (cash register), digital price board, etc.) the real-time price being a second numerical value of a second currency corresponding to an offer to sell the product or service; the central processing device further receiving price modifying data from one or more external data processing devices (e.g., external news databases, etc.), the price modifying data including at least currency exchange rate data between the first currency and the second currency; in response to the receipt of the price modifying data, calculating a value of a current price for the product or service in the first currency in light of the real-time price of the product or service in the second currency; in response to the calculated value of the current price for the product or service in the first currency exceeding a threshold variance from the goal price, automatically sending an alert (e.g., in the form of SMS, email, XML, etc.) to the first user device to modify the real-time price for the product or service in the second currency.

In such an embodiment, the first user device may be a mobile computing device or a desktop computing device, the business location processing device may be a mobile computing device or a physical revenue recording device, and the alert sent to the first user device may be an SMS message, may be an email, or may be machine readable and is communicated via an electronic data interface.

A goal of the present invention is to provide users with both real time and predictive data regarding the finances of their worldwide organizations. Present financial reporting systems have a good deal of latency when reporting information back to corporate management about local sales. This latency prevents companies from making the best business choices as they are constantly forced to make a best guess about what their needs, financial and otherwise, may be in the future.

In one example, a system that provides real-time financial valuation information for entities that process financial transactions across multiple currencies, the system includes: a central processing device that receives transaction data from one or more business location processing devices, the transaction data including quantitative measurements of the financial value of transactions processed by each business location processing device, including at least the value received and any tax liabilities associated with the value received; the central processing device further receiving transaction value modifying data from one or more external data processing devices, the transaction value modifying data including at least one of currency exchange rate data and regional tax liability data; wherein, in response to the receipt of the transaction data and the transaction value modifying data, the central processing device generates modified transaction data comprising the transaction data modified by the transaction value modifying data, the modified transaction data accessible through a graphical user interface provided through an end user processing device, the graphical user interface providing at least one user option for viewing real-time, aggregated, modified transaction data derived from transaction data comprising two or more currencies.

The transaction value modifying data may include one or more currency value modifiers derived from geopolitical events. The transaction value modifying data may include one or more currency value modifiers derived from stock market data. The transaction value modifying data may include one or more currency value modifiers derived from aggregated, anonymized data derived from operational data from a plurality of businesses.

In some embodiments, at least one business location processing device may be a physical revenue recording device or an online payment system. The modified transaction data may include at least one assessment of the current gross worth of the monetary assets of a company, at least one assessment of the current gross worth of the inventory of a company, at least one assessment of the current net worth of the monetary assets of a company, at least one assessment of the fees owed related to the monetary assets of a company, at least one assessment of the refunds owed related to the monetary assets of a company.

The graphical user interface may be displayed in a web browser. The end user processing device may be a mobile computing device.

The system may generate an alert message based off the modified transaction data placing the system into a state of alarm. The alert message generated may be an SMS message, an email, an automated telephonic message, or may be machine readable and communicated via an electronic data interface.

In another example, a system that provides real-time financial valuation information for entities that process financial transactions across multiple currencies includes: an end user processing device providing a graphical user interface, the graphical user interface providing at least one user option for viewing real-time, aggregated, modified transaction data derived from transaction data comprising two or more currencies; wherein the transaction data is received by a central processing device that receives the transaction data from one or more business location processing devices, the transaction data including quantitative measurements of the financial value of transactions processed by each business location processing device, including at least the value received and any tax liabilities associated with the value received; wherein the central processing device further receiving transaction value modifying data from one or more external data processing devices, the transaction value modifying data including at least one of currency exchange rate data and regional tax liability data; wherein, in response to the receipt of the transaction data and the transaction value modifying data, the central processing device generates the modified transaction data comprising the transaction data modified by the transaction value modifying data.

The transaction value modifying data may include data derived from geopolitical events, data derived from stock market data, or data derived from aggregated, anonymized operational data from a plurality of businesses; the transaction value modifying data may feature at least one assessment of the current gross worth of the monetary assets of a company, at least one assessment of the current net worth of the monetary assets of a company, at least one assessment of the fees owed related to the monetary assets of a company, at least one assessment of the taxes owed related to the monetary assets of a company, or at least one assessment of the refunds owed related to the monetary assets of a company; and the system may generate an alert message based off the transaction value modifying data placing the system into a state of alarm, wherein the alert message is an SMS message, is an email, is an automated telephonic message, or is machine readable and communicated via an electronic data interface.

In another example, a system that provides business resource needs forecasts includes: a central processing device that receives real-time resource data from one or more business location processing devices, the company resource data including quantitative data selected from the group consisting of financial data, staffing data, and inventory data; the central processing device further receiving comparison resource data from one or more external data processing devices, the comparison resource data including quantitative data selected from the group consisting of financial data, staffing data, and inventory data, the comparison resource data further being associated with external factor data, the external factor data being selected from the group consisting of economic data, weather data, and political data; the central processing device further receiving real-time external factor data, the external factor data including data selected from the group consisting of consisting of economic data, weather data, and political data; wherein, in response to the receipt of the real-time resource data, real-time external factor data, and the comparison resource data associated with external factor data, the central processing device generates an automated call to action including a suggested modification of the real-time resource data and communicates the call to action to the one or more business location processing devices.

In some examples, the suggested modification of the real-time resource data may relate to staffing needs of a company or inventory needs for a company. The call to action may be an alert message distributed via email, via SMS, via telephonic message, or may be an alert message in a machine readable format and communicated via an electronic data interface.

The business location processing device may be a physical revenue recording device, a mobile computing device, a desktop computer, or business process management software.

In yet another example, a pricing management system includes: a central processing device that receives a goal price for a product or service from a first user device, the goal price being a first numerical value of a first currency; the central processing device further receiving a real-time price for the product or service from one or more business location processing devices, the real-time price being a second numerical value of a second currency corresponding to an offer to sell the product or service; the central processing device further receiving price modifying data from one or more external data processing devices, the price modifying data including at least currency exchange rate data between the first currency and the second currency; in response to the receipt of the price modifying data, calculating a value of a current price for the product or service in the first currency in light of the real-time price of the product or service in the second currency; in response to the calculated value of the current price for the product or service in the first currency exceeding a threshold variance from the goal price, automatically sending an alert to the first user device to modify the real-time price for the product or service in the second currency.

In some examples, the first user device may be a mobile computing device or a desktop computing device. The business location processing device may be a mobile computing device or a physical revenue recording device. The alert sent to the first user device may be an SMS message, an email, or may be machine readable and communicated via an electronic data interface.

In another example, a product and service pricing management system includes: a central processing device that receives transaction data from one or more business location processing devices, the transaction data including quantitative measurements of the financial value of transactions processed by each business location processing device, including at least the value received and any tax liabilities associated with the value received; the central processing device further receiving transaction value modifying data from one or more external data processing devices, the transaction value modifying data including at least one of currency exchange rate data and regional tax liability data; wherein, in response to the receipt of the transaction data and the transaction value modifying data, the central processing device generates modified transaction data comprising the transaction data modified by the transaction value modifying data, the modified transaction data accessible through a graphical user interface provided through an end user processing device, the graphical user interface providing at least one user option for viewing real-time, aggregated, modified transaction data derived from transaction data comprising two or more currencies.

In some examples, the business location processing device may be a mobile computing device or a physical revenue recording device. The end user processing device may be a mobile computing device, a desktop computing device, or business process management software. The alert may be generated based off the modified transaction data. The alert generated may be an SMS message, an email, or may be machine readable and communicated via an electronic data interface.

An advantage of the present invention is that it creates a centralized, real time data collection and reporting system for all transactions, including both cash, card payments or any type of value exchanged. This centralized system creates one version of the truth, allowing companies to no longer have to guess about what their financial resources may be in the future. Using the present system, a member of corporate management can, in real time, view sales for all locations a company has worldwide and, also in real time, address any unusual drop offs in sales, increases in demand, price fluctuations, etc.

Another advantage of the present invention is that it provides intelligent, predictive alerts and advice to end users. Monitoring financial news alone is a difficult task, with entire news organizations dedicated to single segments of the financial sector (e.g., stock market, regulations, etc.). This massive amount of information, plus all other news which may potentially impact a large company's finances, creates a situation where it would be impossible for a large corporation to account for all this information while still running a company. Additionally, the boards and officers of corporations within the US must take into account relevant information when making business decisions or else face legal consequences. The present invention helps corporate management by analyzing all relevant news sources and alerting these users to events throughout the world which may impact their business locally, regionally, and/or globally.

Yet another advantage of the present invention is that it improves user interfaces for information retrieval and review by re-ordering business data into a user friendly format. By providing increased access to such data, the system may aid users in more quickly identifying important business information and also requires less system memory when compared to existing means of reviewing financial data.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic overview of the business data management system.

FIG. 2A is a schematic flowchart of data as it flows through the business data management system.

FIG. 2B is a schematic overview of how the system generates alerts.

FIG. 3A is a schematic overview of how data flows through the system and is displayed for an end user on the GUI.

FIG. 3B is a screen of the system GUI featuring an overview dashboard.

FIG. 3C is a screen of the system GUI featuring a summary of payments made by payment type.

FIG. 4A is a schematic flowchart of the system generating a future resource need analysis.

FIG. 4B is a series of tables illustrating the various methods through which a future resource need analysis may be carried out by the system.

FIG. 4C is a screen of the system GUI showing a future resource need analysis report for staffing needs at a business location.

FIG. 5A is a schematic overview of the system checking that a goal price is being achieved for a given product.

FIG. 5B is a screen of the system GUI showing a report which monitors the goal price of products sold by a company.

### DETAILED DESCRIPTION OF THE INVENTION

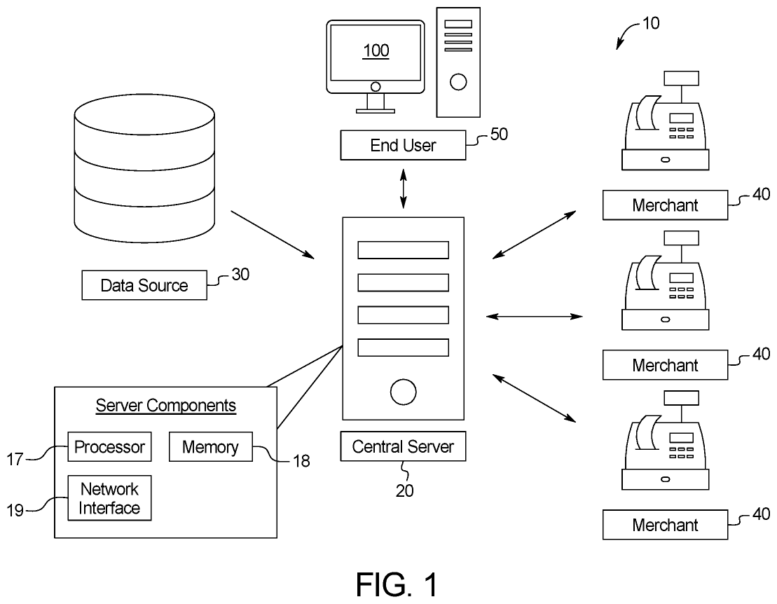

FIG. 1 is a schematic overview of the business data management system 10. As shown in FIG. 1, the system 10 includes a central server 20 (one example of a central processing device 20). This central server 20 includes at least one processor 17, memory 18, and a network interface 19. The memory 18 of the server 20 stores data collected by the server 20 and the data is processed by the server's processor 17. The data analyzed by the system 10 is collected in real time from devices at various business locations, shown in FIG. 1 as business location processing devices 40. The business location processing devices 40 communicate with the server 20 via the network interface 19, which utilizes the internet or any other means of data transmission to communicate between the business location processing devices 40 and the server 20. The business location processing devices 40 can be located throughout the world and correspond to locations in which the business conducts transactions, including storefronts, online stores, etc. The server 20 also collects, in real time, data from various other data sources through external data processing devices 30 that provide relevant business information. Such real time data may include stock market data, geo-political news data, weather data, and any other data which may impact a business.

The system 10 uses the data received from external data processing devices 30 and business location processing devices 40 to provide real time financial information, as well as predictive advice and alerts (i.e., modified transaction data) to an end user 50. The end user 50 may be a corporate management team member, director, company officer, etc. The end user 50 is presented with the real time data generated by the system 10 via a graphical user interface (GUI) 100. This GUI 100 may be accessed by any end user 50 using any computing device with a network connection. Once the end user 50 accesses the system 10 through the GUI 100 on a computing device, the end user 50 is presented with a series of system screens that contain historical, real time, and predictive data about their company's finances and other resources.

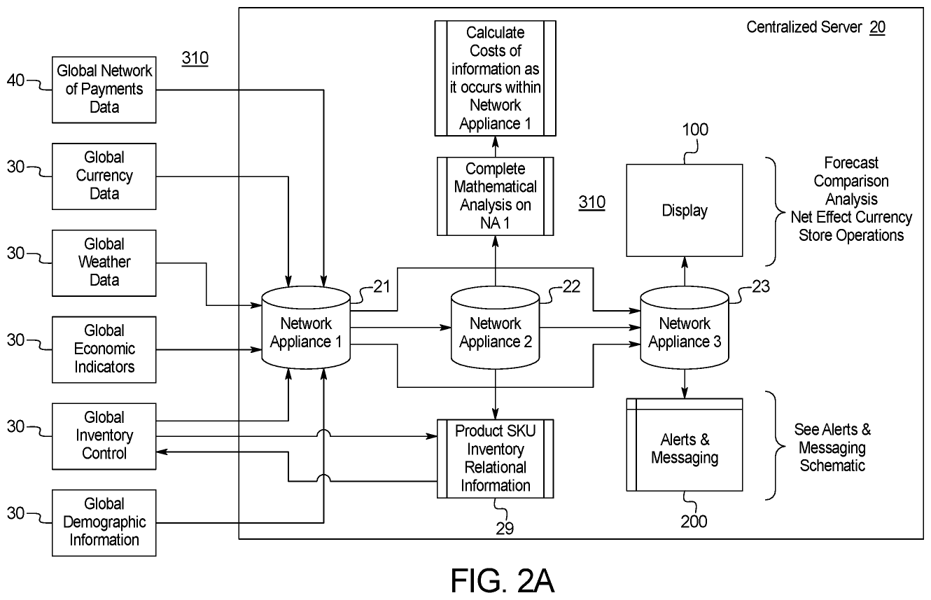

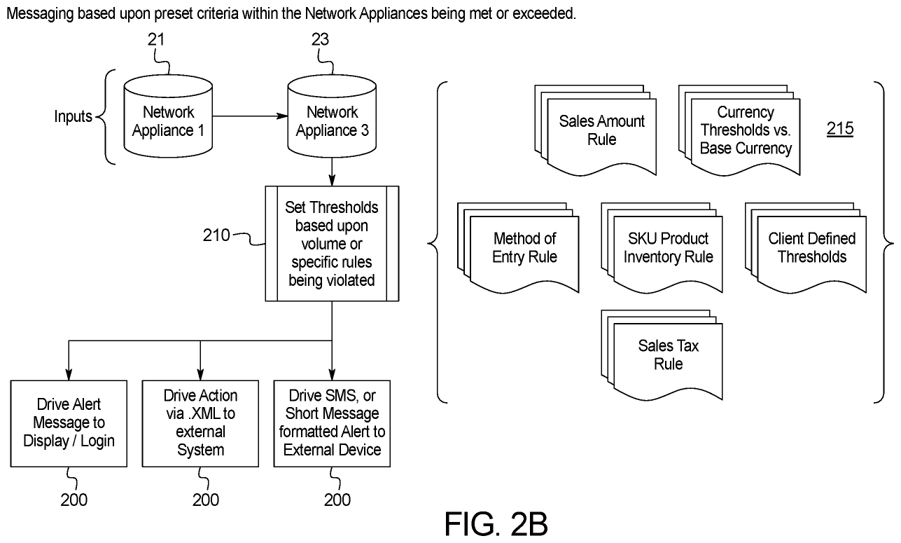

FIG. 2A is a schematic flowchart of data as it flows through the business data management system 10. As shown in FIG. 2A, the data points 310 collected from local business location processing devices 40 is just one set of data collected by the system 10 and transmitted to the central server 20. Real time data from external data processing devices 30 related to currency values, weather, economic indicators, inventory, and demographics may also be transmitted to the system's 10 central server 20. The flow of data is shown in FIG. 2A as a series of arrows. The data flows from the data sources (business location processing devices 40 and data from external data processing devices 30) into the network appliance one 21. It should be noted that throughout this description, there are references to different network appliances. This should not be construed as a requirement any one or more of the network appliances are physically separate from other network appliances. They may be a unified system or disparate constituent parts. Network appliance one 21 represents the functional portion of the server 20 that receives data from the external data processing devices 30 and business location processing devices 40. Once the data has been received by network appliance one 21, the data can then be passed on to other network appliances within the system 10 for further processing and/or action, as described further herein.

As further shown in FIG. 2, network appliance two 22 receives data from network appliance one 21 and analyzes the data to provide end users 50 with intelligent feedback in the form of reports 400, alerts 200, etc. These reports 400, alerts 200, etc., are generated by analysis of the data. The data, described here as various data points 310 generated from this analysis, along with the original data (in the form of data points 310) input into network appliance one 21, is passed to network appliance three 23 for display and alert messaging. Network appliance two 22 also supplies data to a relational database 29 which in turn communicates with the external data processing devices 30. This communication may be used, for example, for purposes of global inventory control. This two-way communication, between the server database 29 and an external data processing device 30, may be carried out over the internet or other communications network in the real time. As described in further detail below, the real time communication may be used to, amongst other things, adjust global inventory pricing based off the analysis performed by the centralized server 20.

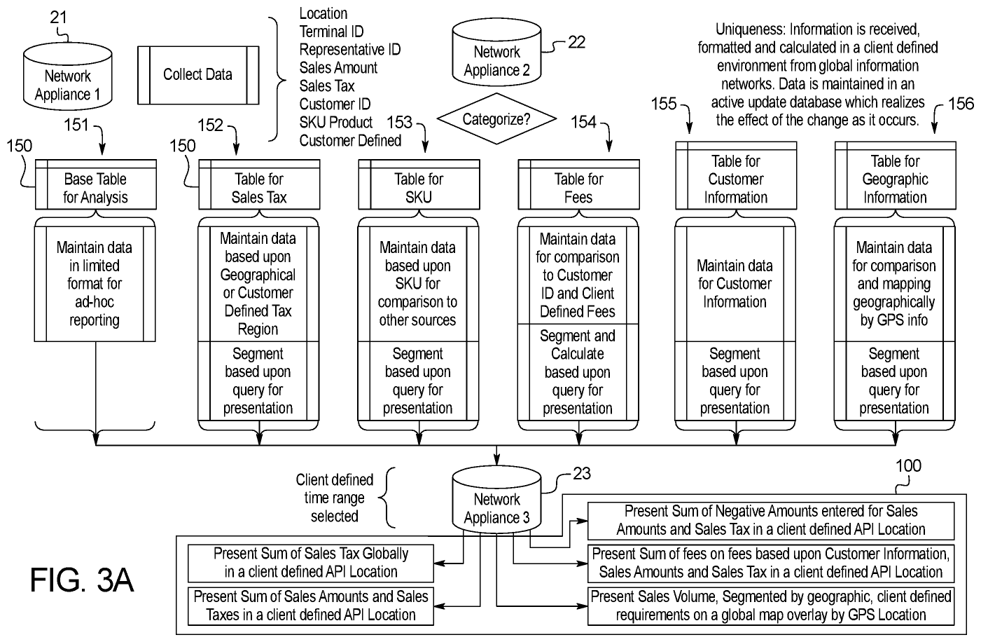

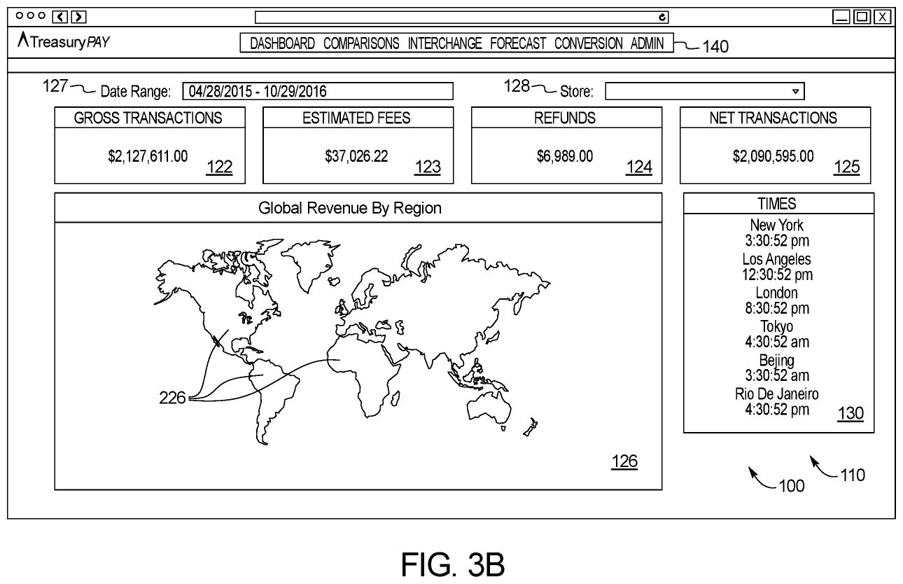

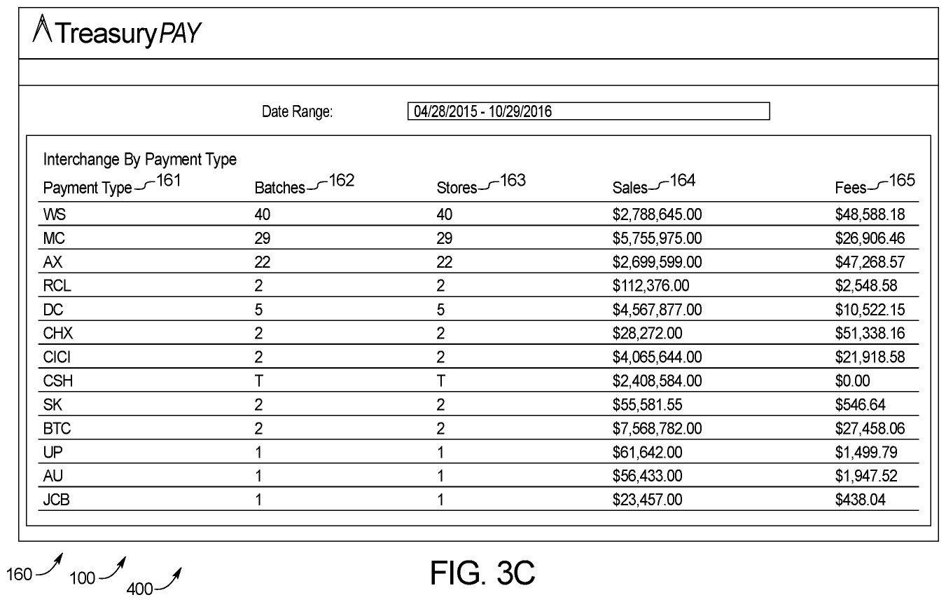

Once the data points 310, both analyzed and raw, reaches network appliance three 23, the central server 20 utilizes the data to display, for the end user 50, historical, real time, and predictive data related to business operations of a given company. This information may be displayed via the graphical user interface (GUI) 100 (shown further in FIGS. 3A-5B) and may include predictive: business forecasts; comparisons; analytics; currency valuations; as well as advice for optimizing operations. Network appliance three 23 may also facilitate the generation of various alerts 200 and other messages sent out by the system 10 in the form of both reactive and predictive alerts 200 (an overview diagram of these alerts 200 is shown in FIG. 2B).

FIG. 2B is a schematic overview of an example in which the system 10 generates alerts 200. As shown in FIG. 2B, the system 10 utilizes the central server 20 and its various network appliances (NA) to generate system alerts 200. In this embodiment, a combination of network appliance one 21 and network appliance three 23 generate the alerts 200. The alerts 200 can also be generated from data points 310 produced as a result of the analysis done by the system 10 via network appliance two 22. Any data points 310 the system 10 records can be used to generate an alert 200, and the alerts 200 can be sent via in any format and through any delivery mechanism as will be obvious to those skilled in the art, including pop-up messages within the system's 10 GUI 100, SMS, email, automated voice messages, etc.

As shown in the example in FIG. 2B, the system 10 generates an alert 200 in response to data that crosses an alert threshold 210. The alert thresholds 210 are defined by various sets of rules 215 that determine when changes in relevant business data require end users 50 to be notified. Each rule set 215 and alert threshold 210 can be set up and adjusted by the end user 50 manually. Alternatively, the system 10 may include default alerts 200. In yet another example, the system 10 may determine that a significant event impacting a business has occurred (or will occur) based analysis of the data collected by the system 10 and automatically create and implement an alert 200.

In an example of a manually created alert 200, the real time data collected from business location processing devices 40 of a given type of business may show a trend for increased demand of a specific product and a business owner may be notified of the increased demand, whether or not his or her store is currently being affected. For this example, a rule set 215 established by the end user 50 is based on the analysis of demand trends within a type of business with the alert threshold 210 set such that when 25% or more of the businesses of a specified classification within 100 miles of a specified location experience at least a 30% increase in demand for any product, the system 10 generates an alert 200 communicated from the central server 20 to a specified end user 50 computing device communicating the product and the degree of increase in demand. As shown in this example the rule set 215 is based on data received from business location processing devices 40 associated with businesses operating in a specified category of commerce, within a given region, and the alert threshold 210 is based on a measure of the number of monitored businesses affected and the degree to which they are affected. However, it is understood that any customized rule set 215 may apply to any data received from either business location processing devices 40 or data from external data processing devices 30 and the alert thresholds may be set in any manner useful to the end user 50, as will be apparent to those skilled in the art.

In an example of an automatically generated alert 200, the system 10 may recognize that staffing needs in a category of businesses have abruptly dropped 15% in a quarter based on the aggregate data from all of the businesses of that type for which the system 10 collects data. In response, the system 10 may automatically generate an alert 200 that notifies each business with the category of the decrease in staffing demands, regardless of whether any specific business has set up such an alert and regardless of whether or not each business is specifically affected by the staffing concern. The automatic alert 200 may be based on recognition of the system 10 of data that falls meaningfully outside of historical norms or a given trend.

As shown, alerts 200 (i.e., a call to action) may be generated by the system 10 for any number of business concerns that may impact a company's finances. In another example, alerts 200 may be set up to inform users 50 of when sales are expected to drop off for storefronts operated around the world. For example, a multi-national chain of ice cream stores operates storefronts around the world. In each region, the seasons vary and the seasonal demand for ice cream varies in some correlated manner. For example, consumption of seasonal goods like cold drinks, ice cream, etc. typically diminish during the cold weather months for a given location. Implementing the system 10, companies do not have to guess about when a change in consumption has occurred; instead end users 50 can set up an alert 200 triggered by a rule set 215 that notifies the end user 50 of changes in consumption in real time. The rule set 215 in this example examines inventory data for each storefront and compares it to previous hours, days, weeks, months, etc. of inventory levels at the corresponding location. The threshold 210 which triggers an alert 200 for a drop in consumption may be set at any level. In one example, a 20% drop in consumption at a given location triggers an alert 200.

Additionally, the present system 10 is capable of providing predictive alerts 200, which differ from the reactive alert 200 in the immediately preceding example. For example, in generating a predictive alert 200 the system 10 can additionally monitor data from the external data processing devices 30, such as weather data, local news, etc., and send an alert 200 to the end user 50 before the drop off in sales actually occurs. For instance, if a snowstorm is forecast to hit Indiana, consumption of ice cream at ice cream stores for the day the storm is to occur will likely drop. The system 10 can account for these upcoming events by other rule sets 215 and thresholds 210; in this case a rule set 215 that examines whether severe weather is expected in the local, regional, or national forecast for a given location and triggers an alert 200 when the level of severe weather exceeds the acceptable threshold 210 (e.g., a winter storm warning being issued for a county in the US triggers an alert 200 informing corporate management that consumptions and/or profits are going to drop for a given location, hopefully such that the location can adjust appropriately).

FIG. 3A is a schematic overview of how data flows through the system 10 and is displayed for an end user 50 on the GUI 100. As shown in FIG. 3A, the system 10 collects data from network appliance one 21 and categories it at network appliance two 22 network appliance two 22 categorizes the data from network appliance one 21 and the data it itself (NA Two 22) generates as part of its analysis (discussed in FIG. 2A). The data is categorized into various databases 150 including a base table 151 which may contain raw data collected from various physical and virtual storefronts a company operates throughout the world (e.g., business location processing devices 40 discussed in FIG. 1). Other databases 150 which are updated by information from network appliance one 21 and network appliance two 22 include a sales tax table 152, a stock keeping unit (SKU) table 153, a fees table 153, a customer information table 154, and a geographic information table 155. The system 10 may utilizes any number of other databases 150 to store and supply information for display by the GUI 100.

The GUI 100 of the present example may feature a centralized dashboard 110 as shown in FIG. 3B, which visually summarizes a company's worldwide global finances along with other business data important to end users 50. The information displayed to end users 50 can be refreshed in real time or with a slight offset in the interval of time (5 min, 15 min, etc.) to allow for a more complete report. When information is updated by a storefront somewhere in the world (e.g., a transaction occurs), the information will be updated within the system 10, which automatically transmits the information to the central server 20 and displays it and its related information such as sales, taxes, fees, etc., to the end user(s) 50 through the end user device 40. All of this information can be easily accessed by the user 50 within the GUI 100 to determine, amongst other things, the amount of money on hand for a company worldwide, regionally, and even at each individual store front. Information related to sales tax and fees, as well as relative value of various currencies accepted by various buying locations, are accounted for by the system 10 in real time when determining the information to be displayed to a user 50. The amount of taxes, fees, and relative value of currencies is highly complicated and constantly changing, but the present system may be configured to account for such changes via the previously mentioned external data processing devices 30 (e.g., data about financial news, geo-political data, etc.).

FIG. 3B is a screen of the system 10 GUI 100 featuring an overview dashboard 110. As shown in FIG. 3B, the dashboard 110 may feature a series of visual displays which contain information related to performance of a given business. In this example, various numerical displays are provided which show the value of a company's worldwide gross transactions 122, estimated fees 123, estimated refunds 124, net transactions 125, and a map 126. Additionally, the map 126 includes clickable locations 226 that direct users 50 to other GUI 100 screens displaying regional information associated with the clicked location 226. The dashboard 110 also displays a clock 130 which provides the local time for each business location that the company operates throughout the world. A menu bar along the top of the dashboard 110 includes links 140 to access other functional aspects of the present system 10 (e.g., business forecast tools, system administration, etc.).

Referring again to FIG. 3A, the present system 10 sorts the data points 310 from network appliance one 21 into various customized databases 150. The tables of these databases 150 are customized for each end user 50 to capture data based upon information provided at the design stage by each end user 50, and can be updated manually or automatically by the system 10 as the reporting needs of the user 50 change and evolve. The information stored in the databases 150 can come from any data source (e.g., business location processing devices 40 or external data processing devices 30) provided to network appliance one 21.

The database 150 may feature tables geared toward global business information. Examples of information contained in such tables include:
Total Sale versus Value Price—a figure which reflects the exchanged receipt of value for a product or service;
Taxes Received—an amount, typically, but not limited to the currency charged by an end-user to supplement corresponding fees by a government;
Account Receivable Entry Method—the way in which the payment was accepted into the accounts receivable system (e.g., cash or credit);
Accounts Receivable Information—a payment type for the exchange of value for the product or service (e.g., Visa or MasterCard);
Customer Demographic Information—a classification of the Accounts Receivable Information that would enable a predefined billing of fees associated to be related;
Approval Information—the authorization information provided by a third party network to accept and account for a given revenue event;
Currency Indicator—a data field that details the value or currency type accepted (e.g., Euro or USD);
Date—the local date of the revenue event; Total Price—The absolute receivable amount in value or currency that represents gross revenue;
Store Location Information—the demographic information which identifies the location of the revenue event;
SKU information=Shopkeeper Unit of the product or service sold;
Product Description—a key code classification of the product or service sold; Discounts—any value granted net of the sale amount; and
Sales Rep ID—an identifier of the responsible party of the revenue event.

Another database 150 may feature tables geared towards global third party valuation. Examples of information contained in such tables include:
Identity—a unique identifier in the network that defines the physical (or virtual) store location of the revenue event;
Base Value Currency—the form in which the revenue event was received in;
Amount—the value received for the revenue event in the given currency;
Quote Value Currency—the pre-determined currency that the end user would like their revenue, costs associated, taxes and net settlement reflected as for analysis;
Outcome—a value the represents the base currency amount in the quote currency;
Message Out—the result of the predetermined comparison within a Third Party Valuation system in an acceptable format to be displayed on behalf of the end user; and
Alert—whether or not a predefined threshold which would enable communication within the operational design of the network appliances or externally via any other functional option has been crossed.

Yet another database 150 is geared towards internal information, with the tables of this database 150 containing proprietary itemized costs associated with any of the end users 50 revenue events. Examples of information contained in such tables include:
Geographic Identifiers—a defined location or identity which provides information pertaining to where the revenue event takes place;
Payment Type—identifies the type of value received by the end user and corresponds directly with potential expense items associated with receiving the revenue (e.g., Visa is a potential payment type and has associated fees);
Value of Currency—the amount received for the revenue event in it native form;
Customer Demographic—a clarification of the customers Payment Type which stipulates the amount billed for the revenue event;
Payment Routing—the route with which the payment is processed, options included international or domestic as these variables relate to additional expense that may be incurred when accepting a payment;
Internal or External Acceptance—whether a payment must be approved internally (e.g., cash, barter, etc.) or externally (e.g., by a credit card provider);
Chip Read—an indicator of a chip set located within a card being read at the time of acceptance of the revenue event which impacts the amount of revenue obtained from a transaction due to contractual agreements with credit card providers; and
Pay Entry Method—the method with which the revenue event was entered into the accounts receivable system (e.g., cash, chip card, card swipe, cashier's check, etc.).

It is important to note the databases 150 discussed above are a mere example of the data points 310 which may be collected by the system 10 based off information collected from business location processing devices 40 and other external data processing devices 30.

Once the information is sorted into databases 150, it is then ready to be transmitted to network appliance two 22 for comparison and analysis via various algorithms. These algorithms assess the actual value of the various revenue events and also review the amount of fees and taxes owed concurrently. For example, if an item was sold for €40 Euro in France, but the end user 50 has set up the system 10 to report information to them in US Dollars, the system 10 would process the information from this transaction, categorize it at network appliance one 21, and analyze it at network appliance two 22. Network appliance two 22 would analyze the transaction based off the real time value of the currency (e.g., Euro to USD) ascertained through various factors taken into account by network appliance two's 22 algorithms. These factors include data points 310 from the various external data processing devices 30 mentioned previously (e.g., FOREX market data, etc.).

Any fees and/or taxes owed by a company are also accounted for in real time based off the same or other data points 310 from the various external data processing device 30 mentioned previously (e.g., real time fee schedules pulled from Visa for international transactions). Continuing with the example above, a fee of 10% may be due to Visa for accepting and processing an international payment. Therefore the storefront that makes the sale in France should collect €4 from the customer. Taxes would also be assessed in this same manner, with all the information analyzed by the system being stored in a database 150 table for query, comparison, and presentation to end users 50 by network appliance three 23.

The example above is a simplified version of the analysis the system 10 may perform on data collected from merchants (such as business location data processing devices 40) and other external data processing devices 30. The system 10 may account for the various fees and other contractual obligations which are tied to payments made by: credit card, debit card, ach, check, mobile wallet, stored value, cash/cash equivalent, private label, crypto-currencies, barter or exchange. Such fees may include, but are not limited to: VAR fees, loan advance repayment, factoring program, organizational levee or duties, shipping/handling fees, bank fees, franchise dues or assessments, or other client predefined fees.

All of this information—revenue, fees, taxes, currency conversions, etc. is sent to network appliance three 23 as needed to generate the information displayed on the GUI 100. As mentioned before, the dashboard 110 features a company's worldwide gross transactions 122, estimated fees 123, estimated refunds 124, and net transactions 125. All of these data points 310 are generated the system 10 performing analysis on every transaction recorded in the system 10. For instance, worldwide gross transactions 122 total $2,127,611 in the example shown in FIG. 3B. This total is a summation of store locations throughout the world including the USA, Japan, and Brazil. The amount for $2,127,611 is presented in US dollars meaning at least some of the data regarding transactions had to be converted from the local currency in which the payments were accepted. All payments not made in USD were converted by the system using real time data from external data processing devices 30 which impacts such currency conversions and valuation.

The totals displayed by system 10 account for all forms of payments including cash and even bartered goods and are reflected in the worldwide gross transactions 122 presented to the user 50. The corresponding values for estimated fees 123, estimated refunds 124, and net transactions 125 are also generated in light of various external data processing devices 30 to give end users 50 a real time valuation of their company's assets. This analyzed data concerning revenue can also be queried by end users 50 using the date range 127 and store 128 input fields to drill down as needed.

The revenue data collected and/or generated by the system 10 can also be exported to various third party financial reporting tools, business resource management software suites, and/or banking systems including: SAP®, SunGard®, JD Edwards (Oracle)®, Kyriba®, or any other revenue accounting system.

While the example above focuses on the system 10 assessing a company's monetary value in real time, the system 10 may also assess the value of other company assets in this same manner. An example of this additional functionality may include real time valuation of a company's inventory using commodities data and other relevant data from external data processing devices 30 that impacts the value of a company's inventory. For instance, the system 10 may utilize information such as fluctuations in the price of rubber or news of an impending embargo on a rubber producing country was being circulated by the press when calculating the value of a tire company's inventory. Like the data from the financial valuation conducted by the system 10 above, the data from any valuation performed by the system 10 can be exported to third party systems to aid a company in obtaining a better view of their business resources.

FIG. 3C is a screen of the GUI 100 featuring a summary of payments made by payment type 161. Users 50 can drill down data sets generated by the system 10 from the main dashboard 110 (see FIG. 3B). In this example, a user has opted to drill down and view a summary of the payments received by payment type 161. The table displayed on this summary screen 160 is a predefined report 400 of the system 10 and shows: the payment type 161, number of payment batches per payment type 162, the number of stores per payment type 163, the total amount of sales per payment type 164, and the total number of fees per payment type 165. The payment type is coded (e.g., VS corresponds to Visa, MC to MasterCard, etc.) in the example shown and the information provided is useful for ensuring all batches of payments have been submitted and that a disproportionate amount of fees are not being paid to any external payment vendors.

Other drill down screens are accessible from the dashboard, including screens featuring real time inventory and staffing reports, financial forecasting charts, risk mitigation information, real time global price analytics, real time sales/fees/taxes reports, real time on-hand cash management information, and the ability to compare multiple business locations performance side by side.

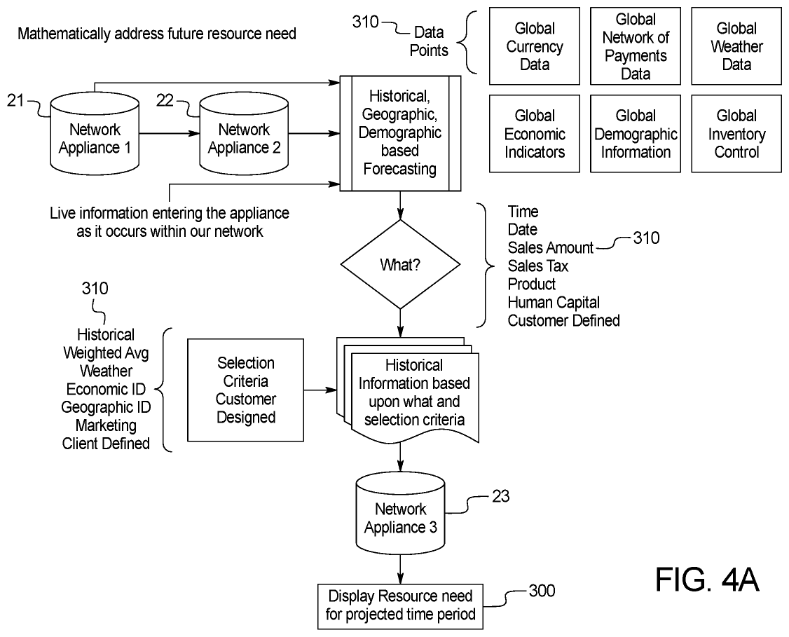

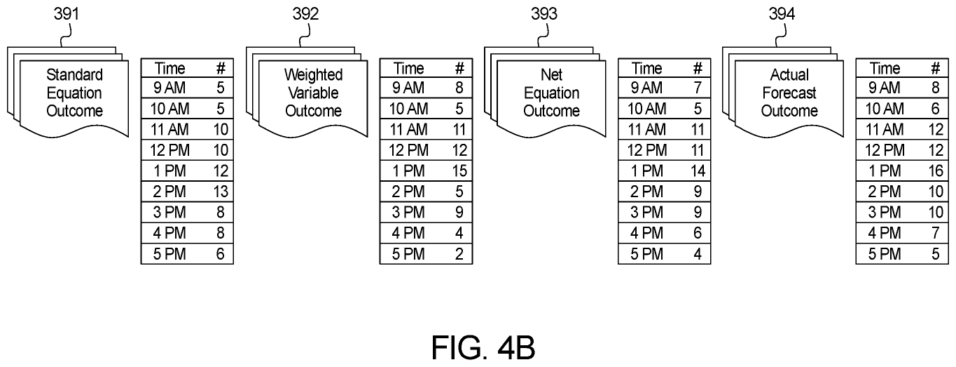

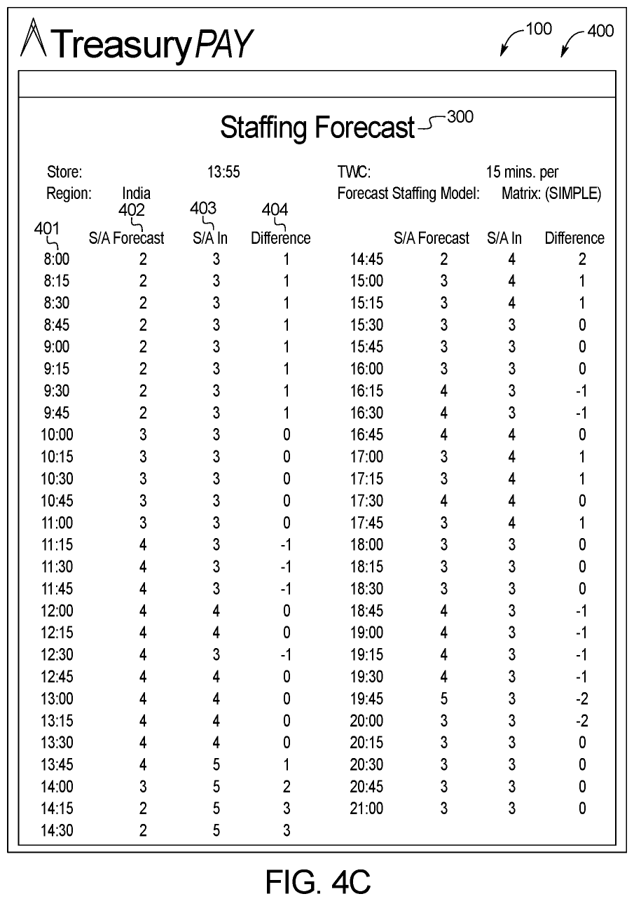

FIG. 4A is a schematic flowchart of the system 10 generating a future resource need analysis 300. Data concerning a company's finances, staffing, inventory, and other company resource data is supplied from various sources including business location processing devices 40 and external data processing devices 30 (shown in FIGS. 1-2A) to network appliance one 21. This data is then supplied to network appliance two 22, which analyzes the data using various algorithms to provide end users 50 with real time and predictive data reports 400 (show in FIG. 4C) and alerts 200 (discussed in FIGS. 2B-3B). Various data points 310 are stored by the system 10 in a database 350 tailored to providing business forecasts. The data points 310 stored in this database 350 may include global currency data, global payment data, global weather data, global economic indicators, global demographic information, global inventory information, etc. All of these data points 310 are updated in real time via data from business location processing devices 40 and external data processing devices 30.

Once the system 10 has been supplied with data from these sources 30, 40, the system 10 can then display to end users 50 via network appliance three 23 a screen featuring a predictive, future resource need analysis 300 which can project staff need, product need, sales, taxes, fees, and overall business performance amongst other business concerns. The end user 50 can select which business concern(s) are to be analyzed by a future resource need analysis 300. The end users 50 may opt to create pre-defined reports 400 (such a report is pictured in FIG. 4C) at during set-up of the system 10 and can also alter the settings of the report 400 as the needs of the user 50 change. The users 50 may also opt to allow the system 10 to automatically evaluate their business needs and provide future resource need analyses 300 based off historical data not only captured from their businesses data, but also from anonymized business data from other corporations who also use the system 10.

Using manual selection, the user 50 may select via the GUI 100 any data points 310 for which they wish to have a future resource need analysis 300 created by the system 10. Additionally, the data points 310 used for an analysis 300 may be weighted. This functionality is important because some data points 310 more heavily influence an analysis than others. For instance, in the preparation of a future needs analysis 300 for staffing needs, both localized weather conditions and global economic indicators are data points 310 which both likely factor into a company's staffing needs. However, local weather conditions are a more important factor than global economic indicators to the staffing needs analysis 300. Thus, the local weather data point 310 may be assigned a modifier (either manually or automatically by the system) which increases the ability of this data point 310 to impact the future needs analysis 300. Automatic weight can be assigned based off real time data or historical data stored by the system 10. The system 10 also allows users 50 to swap data points 310 at any given time to determine the impact of events ranging from global economic conditions, special days (e.g., holidays), marketing programs, the weather, or other similar events.

FIG. 4B is a series of tables illustrating the various methods through which a future resource need analysis 300 may be carried out by the system 10. Depending on the method of analysis performed shown in FIG. 4B, different future staffing needs may be predicted by the system 10. The staffing needs are provided for certain times throughout a business day for a single business location. For instance, at 1 PM on the tables shown, the amount of staff needed according to a standard forecasting equation 391 is 12 staff members. If instead a weighted variable forecasting equation 392 is utilized, the system 10 predicts 15 staff members would be needed at 1 PM. The net equation forecast 393, which accounts for the weighted equation 392 and the unweighted equation 391 averaged together, gives a figure of 14 staffed needed at 1 PM. Finally, the actual forecast equation 394, which is the net forecast 393 averaged with a forecast generated by examining data from external data processing devices 30 and/or anonymized data from other instances of the system 10 (which are also understood to be an external data processing device 30 in this embodiment), produces a figure of 16 staff members needed at 1 PM on this business day. It is important to note that all versions on the equations above provide intelligent feedback, meaning each of them incorporate real time external data processing devices 30 and business location processing devices 40 into the data points 310 each equation uses to generate its forecasted staffing needs. Regardless of the forecasting equation chosen, the forecasted totals for staffing need, inventory need, cash levels, etc. will be monitored by the system 10 and trigger alerts 200 (shown in FIG. 2B) when appropriate.

FIG. 4C is a screen of the GUI 100 showing a report 400 for a future resource need analysis 300 for staffing needs at a business location. The system 10 can generate a real time (in this case 15 min intervals) staffing needs report 400. The report features the time 401, the number of staff needs forecasted 402, the number of staff present 403, and the difference between the forecast and actual staff 404. Taking a closer look at the report 400, from 11:15 AM to 11:45 AM the business location was understaffed by one employee based off the future resource need analysis 300 performed for this day by the system 10. To remedy this issue, the system 10 can send an automated alert 200 to local and/or corporate management to rectify the issue or even send an automated alert 200 directly to an employee designated to fill in on short notice. The alert (i.e. call to action) 200 can be sent by any functional means including SMS, email, or automated telephonic message.

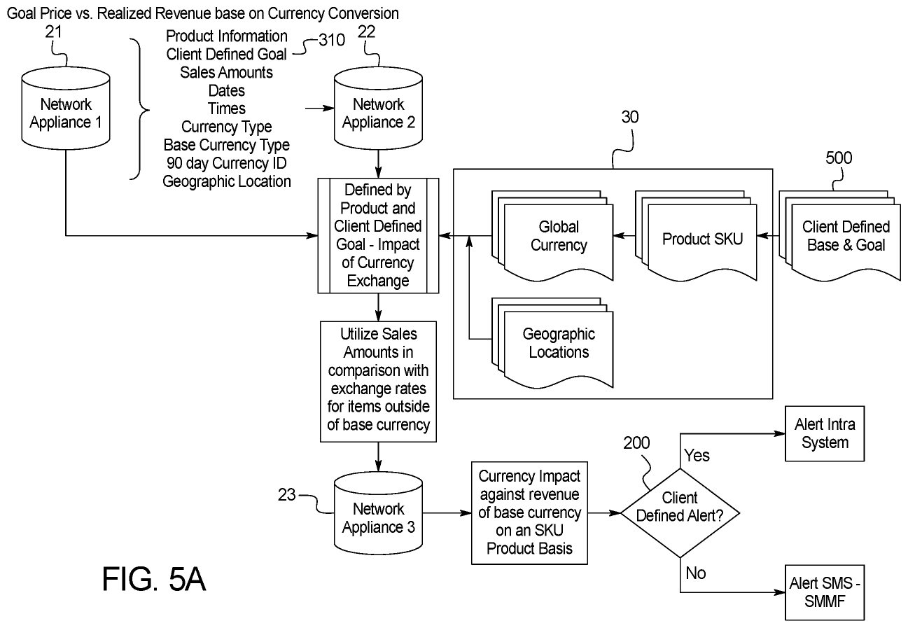

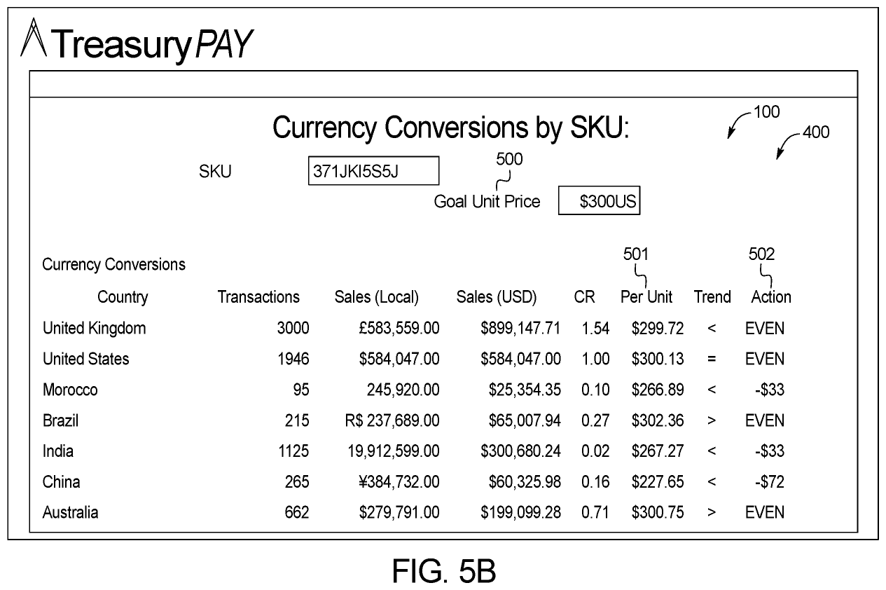

FIG. 5A is a schematic overview of the system 10 to determine whether a goal price 500 is being achieved for a given product. Consistent with the flowcharts of FIGS. 2A, 2B, 3A, and 4A, the system 10 takes data from network appliance one 21 and passes it to network appliance two 22. The data points 310 sent to network appliance two 22 include a goal price 500. This goal price 500 is defined by and end user 50 via the GUI 100 and may also be suggested or set by the system 10 based off real time and/or historical data gathered by the system 10 regarding the ideal price for a given product. The data points 310 include the client's preferred currency which allows the system 10 to determine the relative values of sales made in other currencies. Network appliance two 22 receives the information out of network appliance one 21 and formats the data for comparison. The other data source for this comparison is provided from external data processing devices 30 which may include FOREX, BlockChain (for cryptocurrencies), or any other third party valuation organization. The system 10 may also take other external data processing devices 30 into account including economic indicators, global news, etc. when determining the relative values of currencies. Once the system 10 determines an accurate relative price for a given good or service, it can then compare the actual value received for this good or service as compared to the goal price 500. If the actual value received for a good or service is below the goal price 500, the system can generate an alert 200 (FIG. 2B) and/or adjust the price of the goods or services to avoid additional monetary losses. The system 10 can also be set up to verify that each price is at or above the goal price 500 before authorizing a transaction to proceed, thus preventing a business location from completing a transaction that result in a loss.

FIG. 5B is a screen of the GUI 100 showing a report 400 which monitors the goal price 500 of products sold by a company. The system 10 enables users 50 to monitor and adjust the prices of goods and services sold by a global company. The relative values of currencies all around the world change constantly, with some currencies' values floating relative to others and some having their values set by various governments. This creates a situation in which setting a goal price 500 in one currency ($300 USD in the example shown) creates the need to constantly check that the prices charged in other currencies correspond to a value that matches the goal price.

The report 400 shown in FIG. 5B tracks and updates in real time the relative value of currencies from the various countries in which the company shown in this example does business. The report 400 tracks the goal price 500 as well as the relative value per unit 501 obtained from sales in countries which use a different currency than the goal price. The user 500 is presented with an “action” field 502 which suggests an action to be taken because, for example, the current price of the product being sold in China equates to $72 USD less than the goal price of $300 USD. The system 10 could block any such transactions that would result in a sale at a value less than the goal price 500 or, if integrated with digital signage, update the price in China to a higher amount in local currency in order to satisfy the goal price 500. The system 10 can also evaluate the goal price 500 set by an end user 50 and automatically adjust this price 500 based off external data processing devices 30 to ensure a company is not caught off guard by a natural disaster, undercut by a competitor's flash sale, etc.

While the above examples relate to mitigating losses caused by changes in currency valuation when selling goods, the present system 10 can also account for changes in currency value when determining employee's' wages, moving inventory, or other similar events. One example of this additional functionality is the ability to monitor employees' hourly wages. Based off the example shown in FIG. 5B, the value of the Chinese currency has dropped relative to USD. Therefore, a Chinese worker's wage has less buying power for goods than it did previously compared to other currencies, and, in effect, the worker is making less than he did previously. The present system 10 allows a company to account for drops in the value of a worker's wage along with any mitigating factors to ensure all employees are being paid appropriately.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A system that provides real-time financial valuation information for entities that process financial transactions across multiple currencies, the system comprising:
one or more business location processing devices, each business location processing device providing transaction data including quantitative measurements of the financial value of transactions processed by each business location processing device, including at least the value received and any tax liabilities associated with the value received;
one or more external data processing devices providing transaction value modifying data, the transaction value modifying data including at least one of currency exchange rate data and regional tax liability data and one or more currency value modifiers derived from geopolitical events from stock market data, or from aggregated, anonymized operational data from a plurality of businesses;
a central processing device that receives the transaction data from the one or more business location processing devices;
the central processing device further receiving the transaction value modifying data from the one or more external data processing devices;
wherein, in response to the receipt of the transaction data and the transaction value modifying data, the central processing device generates modified transaction data comprising the transaction data modified by the transaction value modifying data, the modified transaction data accessible through a graphical user interface provided through an end user processing device, the graphical user interface providing at least one user option for viewing real-time, aggregated, modified transaction data derived from transaction data comprising two or more currencies.

2. The system of claim 1, wherein the transaction value modifying data includes one or more currency value modifiers derived from geopolitical events.

3. The system of claim 1, wherein the transaction value modifying data includes one or more currency value modifiers derived from stock market data.

4. The system of claim 1, wherein the transaction value modifying data includes one or more currency value modifiers derived from aggregated, anonymized data derived from operational data from a plurality of businesses.

5. The system of claim 1, wherein at least one business location processing device is a physical revenue recording device.

6. The system of claim 1, wherein at least one business location processing device is an online payment system.

7. The system of claim 1, wherein the modified transaction data includes at least one assessment of the current gross worth of the monetary assets of a company.

8. The system of claim 1, wherein the modified transaction data includes at least one assessment of the current gross worth of the inventory of a company.

9. The system of claim 1, wherein the modified transaction data includes at least one assessment of the current net worth of the monetary assets of a company.

10. The system of claim 1, wherein the modified transaction data includes at least one assessment of the fees owed related to the monetary assets of a company.

11. The system of claim 1, wherein the modified transaction data includes at least one assessment of the refunds owed related to the monetary assets of a company.

12. The system of claim 1, wherein the graphical user interface is displayed in a web browser.

13. The system of claim 1, wherein the end user processing device is a mobile computing device.

14. The system of claim 1, wherein the system generates an alert message based on the modified transaction data placing the system into a state of alarm.

15. The system of claim 14, wherein an alert message generated is an SMS message.

16. The system of claim 14, wherein an alert message generated is an email.

17. The system of claim 14, wherein an alert message generated is an automated telephonic message.

18. The system of claim 14, wherein an alert message generated is machine readable and communicated via an electronic data interface.

19. A system that provides real-time financial valuation information for entities that process financial transactions across multiple currencies, the system comprising:
an end user processing device providing a graphical user interface, the graphical user interface providing at least one user option for viewing real-time, aggregated, modified transaction data derived from transaction data comprising two or more currencies;
one or more business location processing devices that provides transaction data including quantitative measurements of the financial value of transactions processed by each business location processing device, including at least the value received and any tax liabilities associated with the value received;
one or more external data processing devices that provides transaction value modifying data including at least one of currency exchange rate data and regional tax liability data, wherein the transaction value modifying data features at least one assessment of the current gross worth of the monetary assets of a company, at least one assessment of the current net worth of the monetary assets of a company, at least one assessment of the fees owed related to the monetary assets of a company, at least one assessment of the taxes owed related to the monetary assets of a company, or at least one assessment of the refunds owed related to the monetary assets of a company;
a central processing device that receives the transaction data from one or more business location processing devices;
wherein the central processing device further receiving the transaction value modifying data from one or more external data processing devices;
wherein, in response to the receipt of the transaction data and the transaction value modifying data, the central processing device generates the modified transaction data comprising the transaction data modified by the transaction value modifying data.

20. The system of claim 19, wherein:
the transaction value modifying data includes currency value modifiers derived from geopolitical events, from stock market data, or from aggregated, anonymized operational data from a plurality of businesses;
and the system generates an alert message based on the transaction value modifying data placing the system into a state of alarm, wherein the alert message is an SMS message, is an email, is an automated telephonic message, or is machine readable and communicated via an electronic data interface.
